(19) United States
(12) Patent Application Publication
(10) Pub. No.: US 2003/0034728 A1
(43) Pub. Date: Feb. 20, 2003

(54) Plasma display panel

(75) Inventor: Myeong Soo Chang, Uiwang (KR)

Correspondence Address: FLESHNER & KIM, LLP, P.O. Box 221200, Chantilly, VA, 20153-1200, US

(73) Assignee: LG Electronics Inc.

(21) Appl. No.: 10/214,155

(22) Filed: Aug. 8, 2002

(30) Foreign Application Priority Data
Aug. 16, 2001 (KR) 49328/2001

(51) Int. Cl. H01J 31/12; H01J 17/49

(52) U.S. Cl. 313/489; 313/477 R

(57) ABSTRACT

A plasma display panel is disclosed to enhance a light efficiency by using a low-priced filter and enhancing a contrast of a plasma display panel. The plasma display panel includes an electrochromic filter which selectively controls an amount of transmittance of light emitted from a discharge cell within a plasma display panel.

### BACKGROUND OF THE INVENTION

1. Field of the Invention

The present invention relates to a plasma display panel, and more particularly, to a plasma display panel that is capable of improving a contrast of a plasma display panel.

2. Description of the Background Art

In general, a plasma display panel excites a fluorescent layer by using an ultraviolet ray of plasma and displays an image by using a visible light generated from the fluorescent layer.

In a conventional plasma display panel, a contrast is degraded due to a near infrared ray or a visible light generated from a discharge gas and an external visible light irradiated from outside and reflected.

In order to improve the contrast, a liquid crystal filter is adopted to the plasma display panel.

If the liquid crystal filter is adopted to the plasma display panel, a fabrication process is complicated resulting in that an yield rate is degraded and a fabrication cost is increased.

The structure of the conventional plasma display panel adopting the liquid crystal filter will now be described with reference to FIG. 1.

FIG. 1 is a sectional view showing a structure of a plasma display panel in accordance with a conventional art.

As shown in FIG. 1, the conventional plasma display panel includes: a lower insulation layer 9 formed on a lower glass substrate 10; an address electrode 11 formed at a certain portion on the lower insulation layer 9; a lower dielectric layer 8 formed on the address electrode 11 and the lower insulation layer 9; an barrier rib 7 defined at a certain portion on the lower dielectric layer 8 to divide each discharging cell; a black matrix layer 12 formed on the barrier rib 7; a fluorescent layer 13 formed with a certain thickness on the black matrix layer 12, the side of the barrier rib 7 and the lower dielectric layer 8, and receiving an ultraviolet ray to emit each red, green and blue visible light; an upper glass substrate 2; a sustain electrode 3 formed at a certain portion on the glass substrate 2 in a manner of being perpendicularly crossed to the address electrode 11; a bus electrode 5 formed at a certain portion on the sustain electrode 3; an upper dielectric layer 4 formed on the bus electrode 4, the sustain electrode 3 and the upper glass substrate 2; a protective layer 6 formed on the upper dielectric layer 4 in order to protect the upper dielectric layer 4; and a liquid crystal filter 1 adopted on the upper glass substrate 2 and blocking or transmitting the visible ray emitted from the plasma display panel according to whether a voltage is supplied or not.

The operation of the conventional plasma display panel will now be described in detail.

First, a soda-lime silicate (SLS) glass substrate is used as the upper glass substrate 2 and the lower glass substrate 10 of the conventional plasma display panel. The lower insulation layer 9 is positioned on the lower glass substrate 10, the SLS glass substrate, and the address electrode 11 is positioned at a certain portion on the lower insulation layer 9.

The lower dielectric layer 8 positioned on the address electrode 11 and the lower insulation layer 9 blocks the visible light emitted in the direction of the lower glass substrate 10.

In order to increase the luminous efficacy, a dielectric layer with a high reflectance is used as the lower dielectric layer 8.

The fluorescent layer 13 is stacked in order of red, green and blue color, and emits a visible light with a specific wavelength according to an intensity of an ultraviolet ray owing to the plasma generated from the region between the barrier ribs 7.

At a lower side of the upper glass substrate 2, that is, the SLS glass substrate, a sustain electrode 3 positioned crossing to the address electrode 11 in a vertical direction and a bus electrode 5 positioned at a certain portion on the sustain electrode 3. A dielectric layer 4 with an excellent light transmittance is positioned on the bus electrode 5. In addition, a protective layer 6 is positioned to prevent damage of the dielectric layer 4 caused due to generation of the plasma.

Thereafter, when a voltage required for a preliminary discharge is applied to the sustain electrode 3, a voltage difference occurs between the bus electrode 5 and the address electrode 11 perpendicularly crossing to the bus electrode 5.

Due to the voltage difference, the gas position at the region between the barrier ribs 7 becomes a plasma state, and a visible light with a specific wavelength is emitted from the fluorescent layer 13 due to the ultraviolet ray generated from the plasma.

The preliminary discharging refers to a process of generating an electric charge on the dielectric surface (the dielectric layer 4, 8) in order to increase a driving speed of the plasma display panel. When the electric charge is generated on the surface of the dielectric, a basic discharging is being made even in a state that each discharge cell is in an OFF state, so that a small amount of light is generated from each discharge cell.

For example, in the plasma display panel, the discharge gas in a pixel area defined by the barrier rib 7 becomes the plasma state due to a potential difference between the address electrode 11 and the bus electrode 5, and the fluorescent layer 13 is excited by the ultraviolet ray of the plasma to generate a visible light, and an image is displayed by using the visible light.

That is, in the plasma display panel, among the discharge gases constituting of He gas, Xe gas and Ne gas injected into the discharge space partitioned by the barrier ribs 7, the fluorescent layer 13 is excited by using the ultraviolet ray generated by the Xe gas to display a desired color.

At this time, the plasma display panel is to have a high contrast. The contrast is a ratio of brightness between the brightest portion and the darkest portion of a screen. For example, display characteristics of the plasma display panel are enhanced as the difference between the maximum brightness and the minimum brightness is big.

The maximum brightness can be increased by improving a phosphor constitution or the fabrication technique and also can be increased by improving a driving method.

Meanwhile, currently, as the method for increasing the maximum brightness reaches its limits, a method for reducing the minimum brightness is requested instead.

In this respect, however, the preliminary discharging is constantly performed in order to increase a driving speed of the plasma display panel, causing a problem that it is difficulty to reduce the minimum brightness. That is, when the electric charge is generated on the surface of the dielectric in order to increase the driving speed of the plasma display panel, a basic discharging is made even in a state that each discharge cell is in an OFF state, a small amount of light is emitted from each discharge cell.

Thus, in the conventional art, in order to reduce the minimum brightness of the plasma display panel, the liquid crystal filter 1 is formed on the upper glass substrate 2. That is, in the preliminary discharge of the plasma display panel, a voltage is applied to the liquid crystal filter 1 to block the visible light (a small amount of light, that is, dim light) emitted from the plasma display panel, thereby reducing the minimum brightness.

Meanwhile, in case of displaying a screen through the plasma display panel, the voltage applied to the liquid crystal filter 1 is cut off and the visible light emitted from the plasma display panel is transmitted through the liquid crystal filter 1 to display an image.

The liquid crystal filter 1 includes: a lower electrode (not shown) positioned on the upper glass substrate 2; a liquid crystal (not shown) determining a light transmittance when a voltage is supplied thereto; and an upper electrode (not shown) positioned on the liquid crystal.

The liquid crystal filter 1 changes the light transmittance according to the difference between the voltages respectively applied to the lower electrode and the upper electrode, which is a filter type made by simplifying the method used in the LCD.

However, in case of displaying the screen through the liquid crystal filter 1 formed on the upper glass substrate 2, when the liquid crystal filter 1 transmits the visible light, the transmittance of the visible light is reduced so that the overall light efficiency is accordingly reduced.

In addition, in case that the liquid crystal filter 1 is formed on the upper glass substrate 2, the thickness and the weight of the plasma display panel are increased.

Moreover, since the high-priced liquid crystal is used, the fabrication cost of the plasma display panel is increased.

Other plasma display panels and fabricating methods are disclosed in a U.S. Pat. No. 5,838,106 registered on Nov. 17, 1998, a U.S. Pat. No. 6,242,859 registered on Jun. 5, 2001, and U.S. Pat. No. 6,344,080 registered on Feb. 5, 2002.

As mentioned above, the conventional art has many problems

That is, first, in order to improve the contrast by reducing the minimum brightness of the panel, the liquid crystal filter is formed on the upper glass substrate of the plasma display panel. Thus, the light transmittance is reduced, and thus, the light efficiency of the plasma display panel is deteriorated.

In addition, since the liquid crystal filter is formed on the upper glass substrate inside the plasma display panel, the thickness and the weight of the plasma display panel are increased.

Moreover, since the liquid crystal filter using a high-priced liquid crystal is formed on the upper glass substrate inside the plasma display panel, the fabrication cost of the plasma display panel is increased.

### SUMMARY OF THE INVENTION

Therefore, an object of the present invention is to provide a plasma display panel that is capable of enhancing a light efficiency by using a low-priced filter and enhancing a contrast of a plasma display panel.

To achieve these and other advantages and in accordance with the purpose of the present invention, as embodied and broadly described herein, there is provided a plasma display panel including an electrochromic filter which selectively controls an amount of transmittance of light emitted from a discharge cell within a plasma display panel.

To achieve the above object, there is provided a plasma display panel having a plurality of discharge cells and being constructed by forming an barrier rib between an upper glass substrate and a lower glass substrate, including: an electrochromic filter formed on the upper glass substrate and electrically controlling an amount of transmittance of light emitted from the discharge cells on the basis of an electric signal.

To achieve the above object, there is provided a plasma display panel having an upper glass substrate, a sustain electrode formed on the upper glass substrate; a bus electrode formed on the sustain electrode; a lower glass substrate; a lower dielectric layer and an address electrode formed on the lower glass substrate; a fluorescent layer on the lower dielectric layer and the address electrode; and an barrier rib formed on the lower dielectric film, including: an electrochromic filter formed on the upper glass substrate, and electrically controlling an amount of transmittance of light emitted from the discharge cell of the plasma display panel through the upper glass substrate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing the structure of a plasma display panel in accordance with the conventional art; and

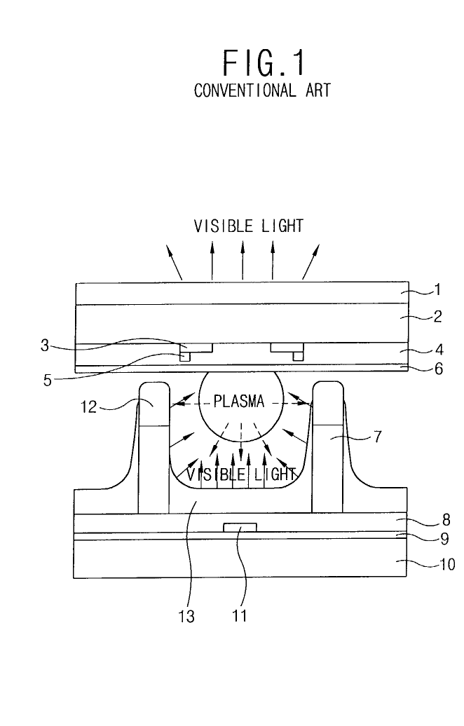

FIG. 2 is a sectional view showing the structure of a plasma display panel in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

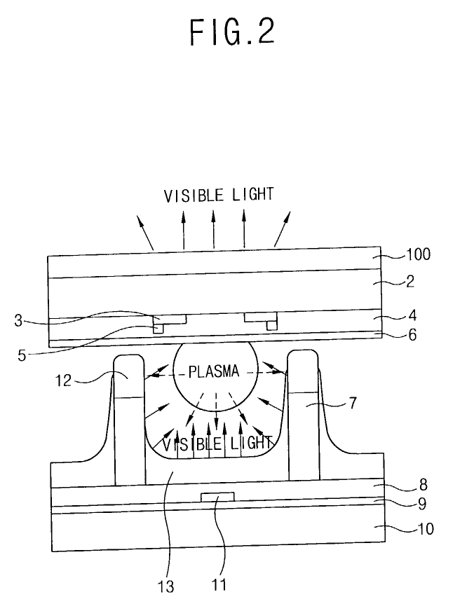

A plasma display panel in accordance with a preferred embodiment of the present invention that is capable of improving a contrast and a light efficiency of a panel by forming an electrochromic filter that selectively controls an amount of transmittance of light emitted from a discharge cell in a plasma display panel on an upper glass substrate that transmits a light emitted from the discharge cell will now be described with reference to FIG. 2.

FIG. 2 is a sectional view showing the structure of a plasma display panel in accordance with the present invention.

As shown in FIG. 2, the plasma display panel includes a lower insulation layer 9 formed on a lower glass substrate 10; an address electrode 11 formed at a certain portion on the lower insulation layer 9; a lower dielectric layer 8 formed on the address 11 and the lower insulation layer 9; an barrier rib 7 defined at a certain portion on the lower dielectric layer 8 in order to divide each discharge cell; a black matrix layer 12 formed on the barrier rib 7; a fluorescent layer 13 formed with a certain thickness on the side face of the black matrix layer 12 and the barrier rib 7 and on the lower dielectric layer 8, and receiving an ultraviolet ray and emitting each red, green and blue visible light; a sustain electrode 3 formed at a certain portion on the upper glass substrate 2 so as to perpendicular cross the address electrode 11; a bus electrode 5 formed at a certain portion on the sustain electrode 3; an upper dielectric layer 4 formed on the bus electrode 5, the sustain electrode 3, the upper glass substrate 2; a protective layer 6 formed on the upper dielectric layer 4 in order to protect the upper dielectric layer 4; and an electrochromic filter 100 positioned on the upper glass substrate 2 and selectively controlling a light transmittance of a light emitted from each discharge cell on the basis of an electric signal in order to enhance a contrast and a light efficiency of the panel.

As a factor evaluating a photo or a picture quality of a screen of a TV set, the contrast refers to a brightness ratio between the brightest portion (maximum brightness) and the darkest portion (minimum brightness).

In the present invention, the brightness of the darkest portion is more darkened by using the electrochromic filter 100, thereby enhancing a contrast of the panel.

In addition, in the present invention, a light transmittance is increased by using the electrochromic filter 100, and a light efficiency of a plasma display panel is increased by the increased light transmittance.

The plasma display panel of the present invention has the same construction as that of the conventional art, except for the electrochromic filter 100, of which descriptions is thus omitted.

The electrochromic filter 100 of the present invention, which is positioned on the upper glass substrate 2 and selectively controls the light transmittance according to whether a voltage is supplied thereto, will now be described in detail.

First, in order to enhance a contrast and a light efficiency of a display panel, the minimum brightness needs to be lowered down, for which the electrochromic filter 100 is positioned on the upper glass substrate 2.

The electrochromic is a material with optical absorption characteristics that varies according to an external electric field or an electric current, including kinds is of WO₃, MoO₃, TiO₂, IrO₂, V₂O₅, or the like.

The electrochromic is a polymer material of which color is changed by light, heat or electricity and called a photochromic or a thermochromic.

Thus, one of WO₃, MoO₃, TiO₂, IrO₂, V₂O₅ is selected and the selected material is deposited on the upper glass substrate 20, thereby forming the electrochromic filter 100.

The materials are transparent when it is not activated (that is, in a state that a voltage (an electric signal) is not supplied), so that it transmits the light of visible light region rather than absorbing it.

Meanwhile, when an external electric field or a current is applied to the materials, an absorption band of visible light area is formed, and absorbs the visible light. That is, when the electric field (voltage) or a current is applied to the electrochromic filter 100, the electrochromic filter 100 absorbs the visible light. Thus, when a voltage is applied to the electrochromic filter 100, the electrochromic filter 100 absorbs a small amount of light emitted from the plasma display panel during a preliminary discharge period of the plasma display panel and reduces the minimum brightness.

The preliminary discharge refers to a process for generating an electric charge on the surface of a dielectric in order to increase a driving speed of the panel, and when the electric charge is generated on the surface of the dielectric, a basic discharge is made even in a state that each discharge cell is off, so that a small amount of light is generated from each discharge cell. The minimum brightness signifies a brightness of a small amount of light.

When the minimum brightness is reduced, the contrast of the panel is enhanced, and when the contrast of the panel is enhanced, a picture quality (characteristics) of the plasma display panel is improved.

Meanwhile, in case of displaying an image through the plasma display panel, the voltage (electric signal) applied to the electrochromic filter 100 is cut off and the visible light emitted from the plasma display panel through the electrochromic filter 100 is transmitted to display a screen.

That is, in the present invention, the visible light emitted from the plasma display panel through the electrochromic filter 100 is transmitted to display a screen, the light transmittance can be increased higher than the conventional liquid crystal filter, and the light efficiency of the plasma display panel can be increased by the increased light transmittance.

The electrochromic filter 100 is formed by coating one of WO₃, MoO₃, TiO₂, IrO₂ and V₂O₅ directly on the upper glass substrate 2 by using a chemical vapor deposition (CVD) method, a sputtering method, an electron beam deposition method and a sol-gel coating method.

In addition, the electrochromic filter 100 can be formed by attaching a layer coated with one material of the WO₃, MoO₃, TiO₂, IrO₂ and V₂O₅, on the upper glass substrate 2.

The electrochromic filter 100 can selectively and easily control an amount of transmittance of light discharged from the discharge cell upon receiving a voltage (an electric signal) applied when the plasma display panel is preliminarily discharged, by using a driving circuit that drive the conventional plasma display panel, without using any additional driving circuit.

In addition, the electrochromic filter 100 may be formed to be position at a front side of the upper glass substrate 2 as necessary.

The electrochromic filter 100 may be fabricated in such a manner that it is independently driven at an upper portion of each cell area, the contrast can be controlled by each discharge cell unit, so that the contrast of the panel can be more improved.

As so far described, the plasma display panel of the present invention has the following advantages.

That is, for example, first, by forming the electrochromic filter for selectively controlling the transmittance amount of light emitted from the discharge cell in the plasma display panel on the upper glass substrate that transmits light emitted from the discharge cell, the contrast of the panel can be more improved than that of the conventional liquid crystal filter.

That is, by enhancing the contrast of the panel, the picture quality of the plasma display panel can be improved.

Secondly, by forming the electrochromic filter for selectively controlling the transmittance amount of light emitted from the discharge cell in the plasma display panel on the upper glass substrate that transmits light emitted from the discharge cell, the light transmittance is more increased than that of the conventional liquid crystal filter, and the light efficiency of the plasma display panel can be increased with the increased light transmittance.

Thirdly, by forming the electrochromic filter for selectively controlling the transmittance amount of light emitted from the discharge cell in the plasma display panel on the upper glass substrate that transmits light emitted from the discharge cell, the plasma display panel can be thin and light-weight.

Lastly, by forming the electrochromic filter for selectively controlling the transmittance amount of light emitted from the discharge cell in the plasma display panel on the upper glass substrate that transmits light emitted from the discharge cell, the fabrication cost of the plasma display panel can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A plasma display panel comprises an electrochromic filter for selectively controlling an amount of transmittance of light emitted from a discharge cell in a plasma display panel on the basis of an electric signal.

2. The panel of claim 1, wherein the electrochromic filter is formed on a glass substrate for transmitting light emitted from the discharge cell.

3. The panel of claim 1, wherein the electrochromic filter is made of one selected from the group consisting of WO₃, MoO₃, TiO₂, IrO₂ and V₂O₅.

4. The panel of claim 1, wherein the electrochromic filter is formed by attaching a layer coated with one material selected from the group consisting of WO₃, MoO₃, TiO₂, IrO₂ and V₂O₅ on a glass substrate transmitting light emitted from the discharge cell.

5. The panel of claim 1, wherein the electrochromic filter is formed by coating on material selected from the group consisting of WO₃, MoO₃, TiO₂, IrO₂ and V₂O₅ on a glass substrate transmitting light emitted from the discharge cell.

6. The panel of claim 1, wherein the electrochromic filter selectively controls an amount of transmittance of light by a voltage applied when the plasma display panel is discharged.

7. The panel of claim 1, further comprises:
an upper glass substrate;
a sustain electrode formed at a certain portion on the upper glass substrate;
a bus electrode formed at a certain portion on the sustain electrode;
a lower glass substrate;
a lower insulation layer formed on the lower glass substrate;
an address electrode formed at a certain portion on the lower insulation film;
a lower dielectric layer formed on the address electrode and the lower insulation film;
an barrier rib defined at a certain portion on the lower dielectric layer in order to divide each discharge cell; and
a fluorescent layer formed on the lower dielectric layer, and receiving an ultraviolet ray to emit each red, green and blue visible light.

8. A plasma display panel having a plurality of discharge cells constructed by forming barrier ribs between an upper glass substrate and a lower glass substrate, comprising:
an electrochromic filter formed on the upper glass substrate, and selectively controlling an amount of transmittance of light discharged from the discharge cells on the basis of an electric signal.

9. The panel of claim 8, wherein the electrochromic filter is made of one selected from the group consisting of WO₃, MoO₃, TiO₂, IrO₂ and V₂O₅.

10. The panel of claim 8, wherein the electrochromic filter is formed on the upper glass substrate transmitting light emitted from the discharge cell.

11. The panel of claim 8, further comprises:
an upper glass substrate;
a sustain electrode formed at a certain portion on the upper glass substrate;
a bus electrode formed at a certain portion on the sustain electrode;
a lower glass substrate;
a lower insulation layer formed on the lower glass substrate;
an address electrode formed at a certain portion on the lower insulation film;
a lower dielectric layer formed on the address electrode and the lower insulation film;
an barrier rib defined at a certain portion on the lower dielectric layer in order to divide each discharge cell; and
a fluorescent layer formed on the lower dielectric layer, and receiving an ultraviolet ray to emit each red, green and blue visible light.

12. A plasma display panel having an upper glass substrate, a sustain electrode formed on the upper glass substrate; a bus electrode formed on the sustain electrode; a lower glass substrate; a lower dielectric layer and an address electrode formed on the lower glass substrate; a fluorescent layer on the lower dielectric layer and the address electrode; and an barrier rib formed on the lower dielectric film, comprising:
an electrochromic filter formed on the upper glass substrate, and electrically controlling an amount of transmittance of light emitted from the discharge cell of the plasma display panel through the upper glass substrate.

13. The panel of claim 12, wherein the electrochromic filter controls the amount of transmittance of light emitted from the discharge cell on the basis of an electric signal.

14. The panel of claim 12, wherein the electrochromic filter is formed by depositing one of WO₃, MoO₃, TiO₂, IrO₂ and V₂O₅ on the upper glass substrate.

15. The panel of claim 12, wherein the electrochromic filter is formed by attaching a layer with one of WO₃, MoO₃, TiO₂, IrO₂ and V₂O₅ coated thereon on the upper glass substrate.

16. The panel of claim 12, wherein the electrochromic filter is formed by coating one of WO₃, MoO₃, TiO₂, IrO₂ and V₂O₅ on the upper glass substrate that transmits light emitted from the discharge cell.

17. The panel of claim 12, wherein the electrochromic filter is controlled by a voltage applied when the plasma display panel is discharged.
